(19) United States
(12) Patent Application Publication
(10) Pub. No.: US 2007/0012157 A1
(43) Pub. Date: Jan. 18, 2007

(54) Peg winder with tuner

(76) Inventor: James D'Addario, Old Westbury, NY (US)

Correspondence Address: ALIX YALE & RISTAS LLP, 750 MAIN STREET, SUITE 1400, HARTFORD, CT, 06103, US

(21) Appl. No.: 11/181,085

(22) Filed: Jul. 14, 2005

(51) Int. Cl. G10D 3/14

(52) U.S. Cl. 84/304

(57) ABSTRACT

A peg winder for use with a stringed instrument in which each string is held in tension by a peg that can be turned by a person holding the instrument to change the tension and thereby tune the string to a target frequency or facilitate peg-winding as is required to install new guitar strings and bring each string up to proper tension. The peg winder is integrated with an electronic tuner such that the tension in the string can be adjusted while the person observes indicia on the tuner indicative of the vibrational frequency of the string. Preferably, the tool also has a string cutter mounted at the back end of the body.

### BACKGROUND OF THE INVENTION

The present invention is directed to a tool for adjusting the tension of strings in a stringed instrument, until the string vibrates at a target frequency.

Many stringed instruments have a plurality of strings that are fixed to the instrument body at one end, while maintained in tension at the other end by an adjustable holding mechanism, such as a peg that can be manually rotated to increase or decrease the tension, and thus vibration frequency, of the string. Although most such pegs are capable of being adjustably rotated by grasping between the thumb and forefinger, the effort can be excessive and the direct manual adjusting may be slow. In order to install a new string onto the instrument, the tuning peg must be rotated quickly and repeatedly. For fine tuning a strung guitar, the musician can hold the guitar in the play position, with one hand positioned to pluck a selected string, and the other hand available to adjust the peg on the neck while the string vibrates. A tuning device is located within the vicinity of the instrument, for comparing the frequency of the vibrating string with a target frequency to which that string is be tuned. The musician plucks and adjust the string tension one or more times until the string vibrates at the target frequency. Conventionally, the tension adjustment and the frequency comparison have been performed sequentially, as distinct but related steps.

### SUMMARY OF THE INVENTION

The present invention not only physically integrates the peg winder and tuner into one tool, but preferably configures the tool such that the frequency comparison is simultaneously displayed while the peg winder is adjusting the string tension. This represents a significant convenience to musicians who perform the task of changing guitar strings, especially home guitar re-stringing routines. Also, this can minimize the delays and distractions associated with keeping an instrument in tune during a performance. As a further improvement to minimize the time involved in replacing a string, a string cutter is preferably integrated with the peg winder and tuner.

Thus, the present invention is more particularly directed to a tool for a stringed instrument in which each string is held in tension by a peg having a head with standard external profile, whereby the tool facilitates turning of the pegs rapidly to take up slack, as is the case when new strings are installed. The string can be readily brought to target frequency (musical pitch) by a person holding the instrument to change the tension. The device is integrated with an electronic tuner such that the tension in the string can be adjusted while the person observes indicia on the tuner indicative of the vibrational frequency of the string.

In one particular embodiment the tool comprises a elongated body having front and back ends and an exterior surface shaped for grasping in one hand. A peg winder projects from the front end of the body and includes an end-effector formed with an internal profile that is complementary to the peg profile. A transducer is at one location at the surface of the body, for receiving energy from a vibrating string to be tuned. A tuning indicator is visible at another location at the surface of the body, for generating a signal commensurate with the difference between the vibration frequency of the plucked string and the target frequency.

Preferably, the tool also has a string cutter mounted at the back end of the body. In one embodiment, the string cutter comprises a first cutting arm with first cutting edge rigidly extending from the back end of the body, and a second cutting arm pivotally mounted at the back of the body and extending along the top exterior surface of the body, whereby the second arm can be selectively pivoted between open and closed positions away from and adjacent to the body. The second cutting arm has a second cutting edge confronting the first cutting edge such when the second arm is in one position a string can be placed between the cutting edges and when the arm is in the other position the cutting edges sever the string.

### BRIEF DESCRIPTION OF THE DRAWINGS

FIG. 1 is perspective view of a tool for a stringed instrument in which a tuner is integrated with a peg winder and string cutter, according to one embodiment of the invention;

FIGS. 2-5 are left side, bottom, right side, and top views, respectively, of the tool of FIG. 1;

FIG. 6 is a detailed perspective view of the peg winder of the tool of FIGS. 1-5, and as would appear on a similar tool without the string cutter feature;

FIG. 7 is an exploded view of the tool of FIGS. 1-5;

FIG. 8 is a block diagram of the electrical circuit of an electronic tuner usable with the present invention for tuning a musical instrument; and

FIG. 9 is a front view of a preferred form of a display interface usable with the present invention.

### DESCRIPTION OF PREFERRED EMBODIMENTS

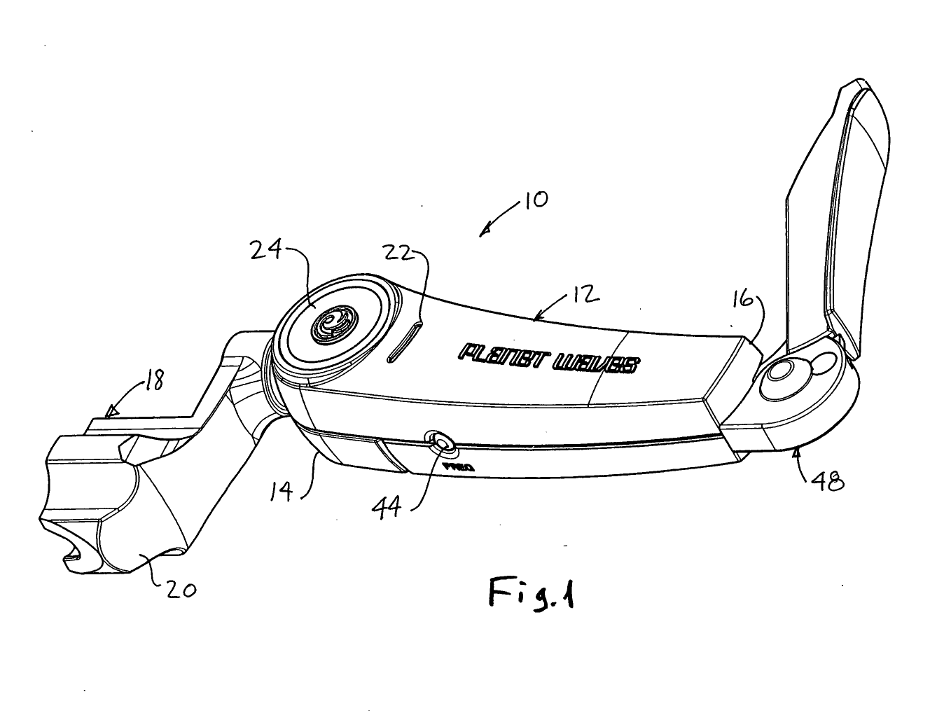

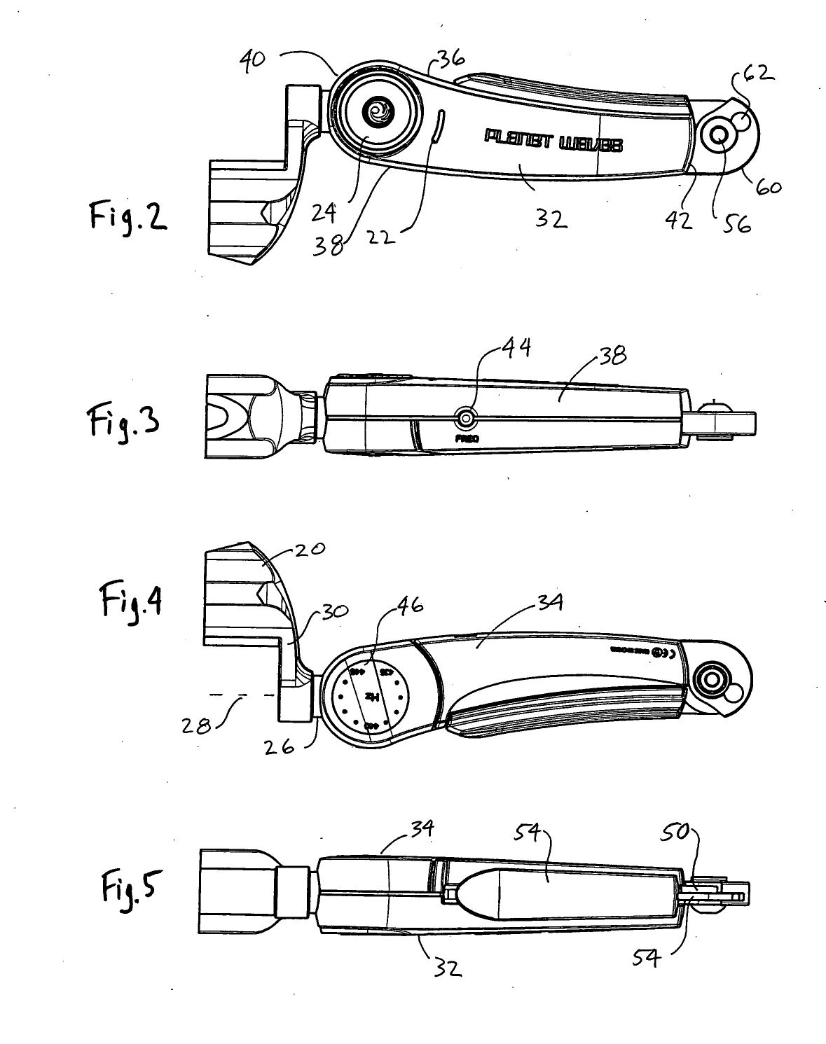

FIGS. 1-5 show a tool 10 for a stringed instrument in which each string is held in tension by a peg having a head with standard external profile that can be tuned by a person holding the instrument to change the tension and thereby tune the string. An elongated body 12 has front 14 and back 16 ends shaped for grasping in one hand while the instrument is held for tuning. A peg winder 18 projects from the front end of the body and includes an end-effector 20 formed with an internal profile that is complementary to the standard profile of the peg. A tuning system is situated in the body, including a transducer 22 for receiving energy from a plucked string to be tuned, a frequency analyzer coupled to the transducer for comparing the fundamental frequency of vibration of the plucked string with a target frequency, and a display 24 coupled to the frequency analyzer and visible on the body. The display 24 includes an indicator 46 commensurate with the difference between the analyzed fundamental frequency of the plucked string and the target frequency, which is selectable via switch 44 or the like. The peg winder 18 includes a stem 26 rigidly projecting from the front end of the body along a stem axis 28 that passes longitudinally through the body and an arm 30 extending transversely to the stem axis and rotatably mounted on the stem. The end effector 20 rigidly projects from the arm.

The body 12 is preferably formed by spaced apart, left 32 and right 34 side surfaces, opposed top 36 and bottom 38 surfaces that connect the side surfaces, and front 40 and back surfaces 42 that together with the side and top surfaces form a closed handle 12 sized and shaped to fit in a person's closed hand with the stem axis 28 oriented in substantially in the same direction as the lifeline of the closed hand. The side surfaces 32, 34 of the body increase in area from the back to the front ends and the tuning indicator 24 is adjacent the front end. The top 36 and bottom 38 surfaces of the body are curved in the same direction, but with different radii of curvature.

Optionally, the tool has a string cutter 48 mounted at the back end. The string cutter 48 comprises a first cutting arm 50 with first cutting edge 52 rigidly extending from the back end of the body, and a second cutting arm 54 pivotally mounted 56 at the back of the body and extending along the top 36 exterior surface of the body. The second arm 54 of the string cutter is curved at substantially the same radius of curvature as the body top surface. The second arm 54 can be selectively pivoted between open and closed positions away from and adjacent to the body, respectively. A second cutting edge 58 confronts the first cutting edge 52 such that when the second arm is in one position a string can be placed between the cutting edges and when the arm 54 is in the other position the cutting edges sever the placed string. A shield 60 with through hole 62 can be secured to the body such that the hole 62 permits passage of the string between the cutting edges to be severed when the second arm is moved to the cutting position.

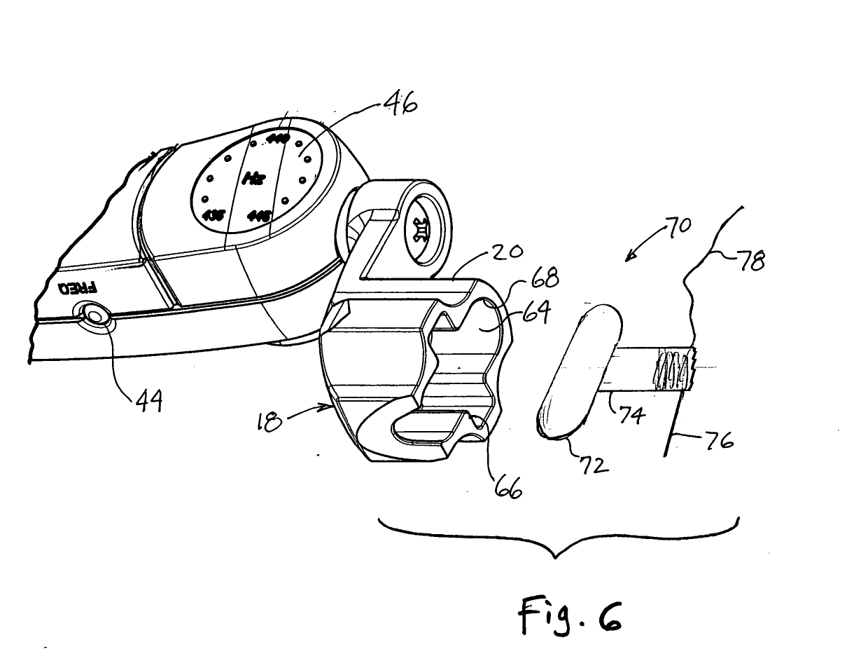

FIG. 6 shows further details of the preferred form of the end effector 20 with a portion 44, 46 of the associated tuner at the front portion of the body. It should be appreciated that in this embodiment, no string cutter is present, but the remainder of the body and tuner are substantially identical to the corresponding structure described with respect to FIGS. 1-5. The end effector 20 is rotatably mounted to the front of the body, and has a recess 64 defined by wall structure forming, for example, an asymmetric cross. This results in a first socket defined by a pair of notches 66 that can conform to an oval peg head whereas a second socket is defined by the other pair of notches 68 that can conform to a rectangular peg head. A portion 70 of a stringed instrument is shown adjacent the end effector 20, whereby the peg head 72 can be closely received in notch 68, for rotating the peg stem 74, which in turn increases or decreases the wrapping of the string. The wrapping affects the tension and thus vibration frequency in the voice portion 76 of the string, whereas the free end 78 of the string can remain untrimmed. In the preferred embodiment of the invention as shown in FIG. 1, after tuning has been achieved, the tool is reversed and the free end 78 of the string can be trimmed.

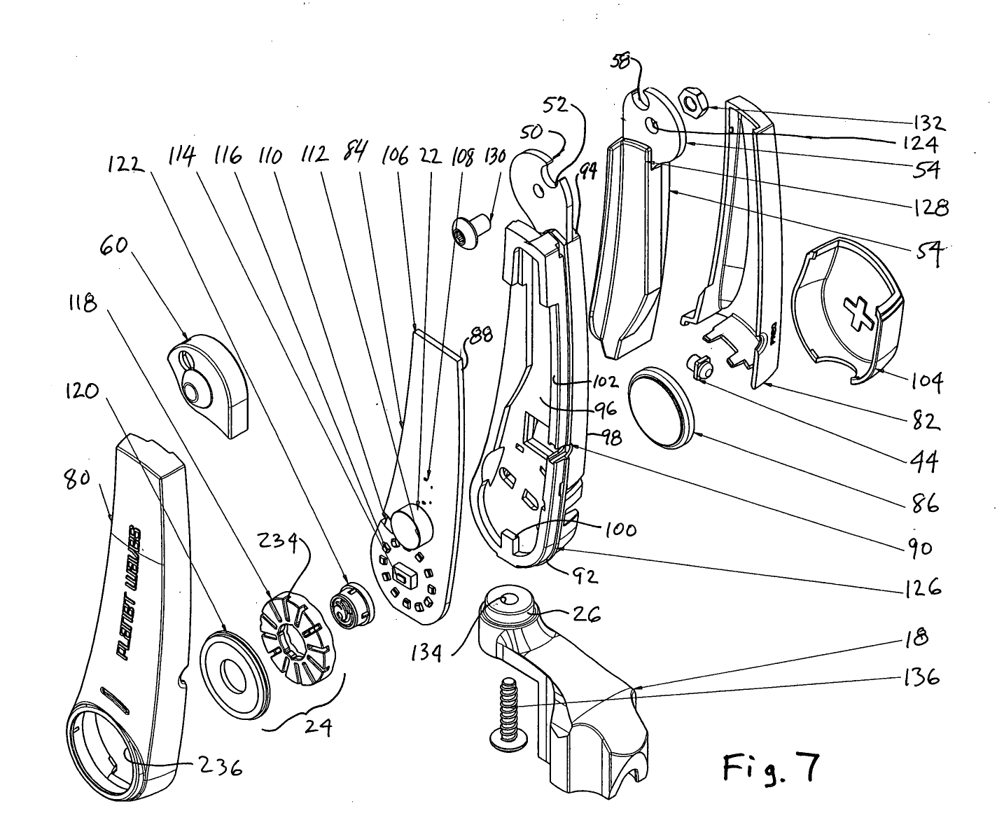

FIG. 7 is an exploded view of the tool shown in FIGS. 1-5. The body is primarily formed by two half-shells, 80, 82. A tuner mounting plate 84 is situated between the shells, adjacent the shell 80 having the surface where the tuning display 24 is located. The transducer 22 and the tuning display 24 are situated between the tuner mounting plate 84 and the shell 80, and a battery 86 for the tuning system is situated between the tuner mounting plate 84 and the other shell 82. The tuner mounting plate 84 is substantially flat with a peripheral edge 88. A core plate 90 is situated between the tuner mounting plate 84 and the other shell 82, the core plate having front and back ends, 92, 94 a first side facing 96 the tuning plate, and a second side 98 facing the other shell 82. The first side has a web 100 at the front end and a peripheral edge 102 that support the peripheral edge 88 of the tuner plate. The first, rigid or fixed string cutter arm 50 is integral with and extends from the core plate 90 through the back end of the body.

A positive battery contact 110 is located at the periphery of the plate 84, and the negative contact 112 is located adjacently, at the center of the plate. These contact the battery 86 on the side of the plate facing shell portion 82. A battery cover 104 secures the battery in place against the contacts on this side of the plate 84.

The tuner mounting plate 84 is a printed circuit board (PCB) 106. On the side facing shell portion 80, the transducer 22 includes a microphone carried by the PCB, and the display 24 includes a plurality of LED's 116 carried by the PCB. A miniature, tactile power on/off switch 114 is mounted on the PCB, and a power select button 122 is accessible at the surface of the body for operative association with the power on/off switch. The display includes an annular lens 120 surrounding the power button 122 at the body surface with indicia that are selectively illuminated by the LED's.

A miniature tactile switch 108 is located on the side of the plate 84 facing shell portion 82, and is aligned with core 90 and includes a recess for receiving a switch (44 as shown as FIG. 5) for selecting the target frequency, as will be described in greater detailed below.

The display 24 preferably includes not only the lens 120, but a light pipe 118, having a plurality of light-transmitting passage ways corresponding respectively to the plurality of LED's 116.

In the illustrated embodiment, which includes a string cutter, the moveable string cutter arm 54 is part of an assembly 128 including a cutter handle 128 with a flange portion that is accessible at the exterior of the body for operating the arm, and a support portion which is rigidly connected to the arm 54, in which nest in a corresponding contour formed in the body portion when the body is assembled. Each of the cutter arm 54, 54 has a central aperture 124 through which a pivot pin 130 passes and is secured therein via knot 132. Thus, the core 90 can be considered as the frame work for a core arm assembly 126 that remain fixed with respect to the body, whereas the arm 54 is pivots in relation thereto, about pin 130.

FIG. 7 also shows the peg winder portion 18 whereby the stem portion 26 includes a central aperture 134 though which a mounting screw 136 passes, to secure the peg winder 18 to the front end of the body. The stem 26 has a groove or channel which allows the user to ‘stretch’ the string, if desired, thus helping the target frequency to settle more quickly, without repeated re-tunings.

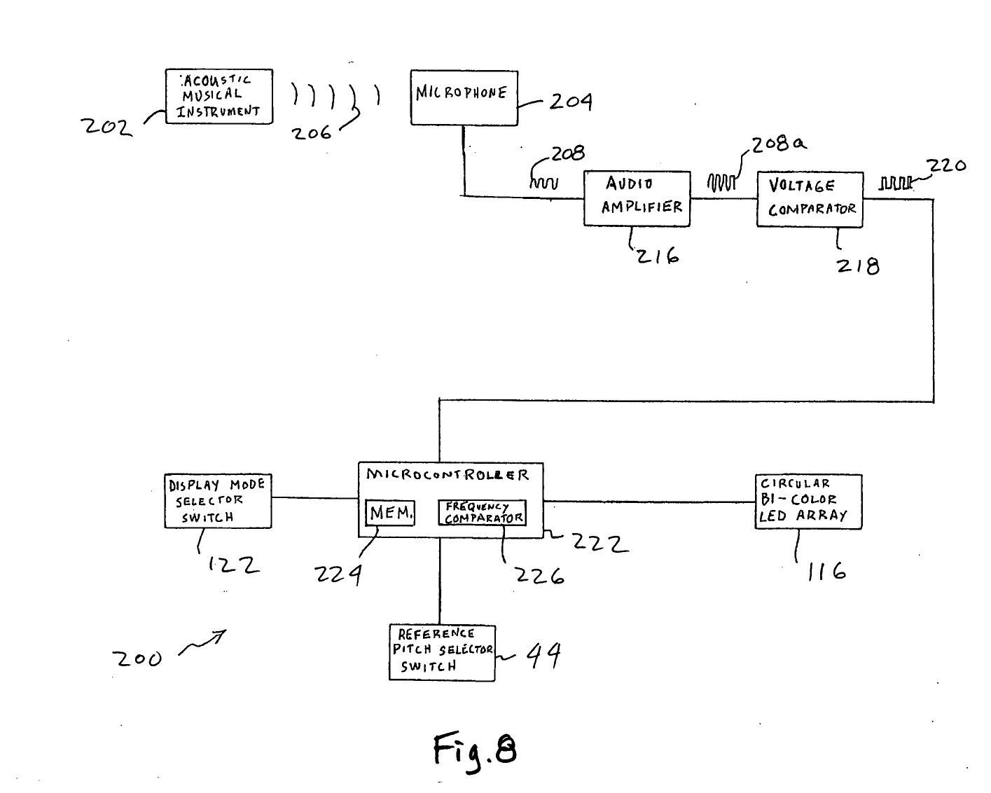

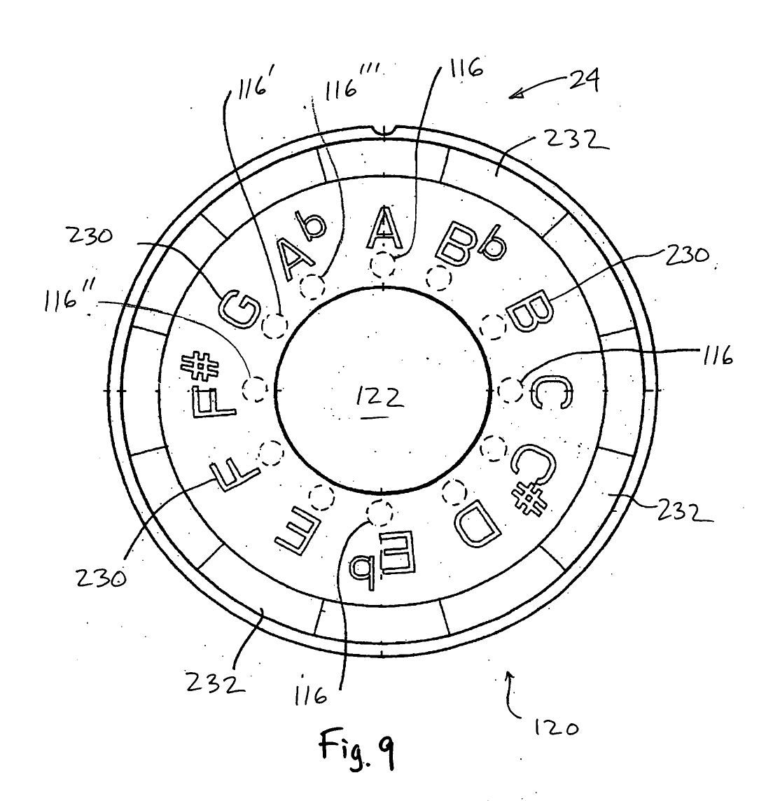

FIGS. 8 and 9 show the preferred implementation of the tuner aspect of the invention, as a supplement to FIG. 7.

FIG. 8 is a block diagram of a circuit 200 of suitable electronics, which controls the illumination of the display interface 24, 116 connected thereto. When the instrument to be tuned is an acoustic musical instrument 202, a microphone 204, preferably internal to the electronic tuner, receives acoustic waves 206 from the acoustic instrument. The microphone acts as the transducer 22 of FIG. 1, converting the acoustic waves 206 to an output electrical analog sine wave signal 208 having a frequency which corresponds to that of the musical note played on the instrument.

The circuit 200 of the electronic tuner further includes an audio amplifier 216 which receives the electric signal 208 and amplifies it, thereby generating amplified analog sine wave signal 208a. The amplified analog sine wave signal 208a is provided to a voltage comparator 218, which clips the amplified analog sine wave signal 208a and converts it to a digital logic electrical signal 220, so that it is compatible for operation with the remaining digital components of the tuner circuit. A microcontroller or microprocessor 222 is coupled to the voltage comparator 218 and receives the digitized electrical signal 220. The microcontroller 222 includes, either internally or externally, a storage memory 224, which stores the frequencies corresponding to twelve musical notes, e.g., the fundamental frequencies for notes A, A#/(Bb), B, C, C#/(Db), D, D#/(Eb), E, F, F#/(Gb), G and G#/(Ab). Microcontroller 222 also includes, either internally or externally, a frequency comparator 226. The microcontroller 222 determines by means of the frequency comparator 226 which of the fundamental frequencies corresponding to the musical notes stored in the storage memory 224 the electrical signal 220 most closely equals.

The display interface of the present invention, in the form of an optical display, preferably includes a circular array of circumferentially spaced apart bi-color light emitting diodes (LEDs) 116, connected to and driven by the microcontroller 222. Each of the LEDs 116 represents one of the fundamental frequencies of the musical notes mentioned previously. The tuner circuit 200 also includes a display mode selector switch 228 and a reference pitch selector switch 122, each of which is operatively coupled to the microcontroller 222.

FIG. 9 illustrates a preferred form of the display interface 24 of the present invention, having a note dial 120, illuminated by the circular array of bi-color LEDs 116 described previously. The note dial 120 displays characters 230 representing twelve musical notes: A, A#/(Bb), B, C, C#/(Db), D, D#/(Eb), E, F, F#/(Gb), G and G#/(Ab). Preferably, the notes are circularly arranged in a manner like the dial of a clock so that note A is at the 12 o'clock position, note C is at the 3 o'clock position, note Eb is at the 6 o'clock position, and note F# is at the 9 o'clock position. The display mode selector switch 122, which also functions as a power on/off switch, is preferably disposed at the center of the note dial. Of course, it is envisioned that a separate power switch may be included, if desired. Preferably viewable at the outer circumference of the note dial 120 is an array of transparent, illuminatable segments 232 that are circularly arranged radially outwardly of the characters 230. These segments 232 are viewable portions of a light pipe 118 situated behind the note dial 218. Preferably, the LEDs 116 are disposed behind the musical note characters 230 and the transparent segments 232. Thus, each of the musical note characters 230 and the transparent segments 232 is illuminated simultaneously by a respective LED situated behind them.

The cylindrically-shaped light pipe 118, has radially extending slits 234 formed in its front surface and rear surface, to define twelve individually illuminatable segments 232, situated adjacent to the circular array of LEDs 116. The rear surface of the light pipe has further formed therein recesses or openings, one opening situated within each segment 232, to receive the LEDs 116. Accordingly, when any given LED 116 illuminates, the corresponding segment 232 of the light pipe is illuminated thereby.

The disc-shaped note dial 120 is situated concentrically over the front surface of the light pipe 118. The note dial has a smaller diameter than that of the light pipe so that only the outer portions of segments 232 not blocked by the note dial are viewable to the user. As mentioned previously, the note dial 120 has imprinted on the surface thereof indicia in the form of the twelve musical notes 230 of one octave. The note dial is preferably opaque, except for the note indicia 230. Each note indicia is situated in alignment with one corresponding segment 232 of the light pipe 118 so that the note indicia 230 appears as being backlit and readable by a user when a corresponding LED 116 illuminates.

Each of the light pipe 118 and the note dial 120 has formed centrally through the thickness thereof an opening, respectively, to receive the pushbutton cap of switch 122. The pushbutton cap 122 includes a radially extending flange 234 so that it is held captive within the tool body by the light pipe 118 and note dial 120, but moveable within the openings so that it may be pressed by a user to activate switch 114.

The note dial 120 is aligned with an opening 236 formed in the front half of the housing tool body. The diameter of the opening 236 is slightly smaller than that of the note dial so that the note dial is held captive within the interior of the body.

In the sweep mode of operation, the LED 116′ corresponding to the note played lights up in one color, for example, green, designated by the letter G. An LED 116″ in a different color, for example, red, will appear counter-clockwise of the green LED 116′ if the note played is flat, and clockwise of the green LED 116′ at 116′″ if the note is sharp. When only the green LED 116′ is lit, the instrument is in tune with respect to that note played.

It should be noted that the microprocessor 222 can pulse width modulate the illumination of a plurality of adjacent red LEDs 116″ or 116′″ to show a smooth movement of the pitch of the played note as the musical instrument is being tuned. Thus, only one green LED 116′, signifying the reference note G, is illuminated at any one time, but two adjacent red LEDs signify how sharp or flat the played note is, may be pulse width modulated to at least partially illuminate together to provide a smoothly varying display.

Alternatively or additionally, when the user presses the mode pushbutton switch 122 a second time, the electronic tuner enters the strobe mode of operation. The LEDs 116 illuminate sequentially in red around the note dial 120 a few times to indicate to the user that the tuner is in the strobe mode. In the strobe mode of operation, the LED 116′ corresponding to the note played lights up in one color, for example, green. The other LEDs sequentially illuminate in a different color, for example, red, in either a counter-clockwise or clockwise direction about the note dial 120. Both the direction and speed of the illuminating red LEDs provide information to the user as to how out of tune the instrument is. When the red LEDs illuminate sequentially in a counter-clockwise direction, this indicates that the played note is flat compared to the reference note G. When the red LEDs 116 sequentially illuminate in a clockwise direction, this indicates to the user that the played note is sharp compared to the reference note G. The angular velocity or speed at which the red LEDs sequentially illuminate is proportional to how sharp or flat the played note is. As the instrument is tuned so that the frequency of the played note approaches the frequency of the reference note, the angular velocity or speed at which the red LEDs sequentially illuminate decreases and then stops, indicating that the note is in tune.

Returning again to FIG. 8, the circuit 200 includes a reference pitch selector switch 44. The electronic tuner operates on a standard pitch of 440 Hz for the note A. However, it is often desired to tune a musical instrument to a slightly different reference frequency from that of the standard pitch of 440 Hz. Accordingly, the electronic tuner provides the user with the ability to select a different reference frequency, preferably between 435 Hz and 445 Hz for note A. The selected frequency is indicated on display 46 at the front of the body on the side opposite display 24.

1. A tool for a stringed instrument in which each string is held in tension by a peg having a head with standard external profile that can be turned to change the tension and thereby tune the string to a target frequency, comprising:
an elongated body having front and back ends and an exterior surface shaped for grasping in one hand;
a peg winder projecting from the front end of the body and including an end-effector formed with an internal profile that is complementary to said standard profile;
a transducer at the surface of the body for receiving energy from a vibrating string to be tuned; and
a tuning indicator at the surface of the body adjacent the front end, for generating a signal commensurate with the difference between the vibration frequency of the plucked string and the target frequency.

2. The tool of claim 1, wherein the peg winder includes a stem rigidly projecting from the front end of the body along a stem axis that passes longitudinally through the body and an arm extending transversely to the stem axis and rotatably mounted on the stem, with said end effector rigidly projecting from the arm.

3. The tool of claim 1, wherein the body has spaced apart, left and right side surfaces, opposed top and bottom surfaces that connect the side surfaces, and front and back surfaces that together with the side and top surfaces form a closed handle sized and shaped to fit in a persons' closed hand with the stem axis oriented substantially in the same direction as the lifeline of the closed hand.

4. The tool of claim 3, wherein the side surfaces of the body substantially continuously increase in area from the back to the front ends.

5. The tool of claim 4, wherein the transducer is located on the same side surface as the tuning indicator.

6. The tool of claim 3 including a target frequency selector at the bottom surface of the body, and a target frequency indicator located on the surface of the body opposite to the location of the tuning indicator.

7. The tool of claim 1, comprising a string cutter mounted at the back end of the tool.

8. The tool of claim 7, wherein the string cutter comprises a first cutting arm with first cutting edge rigidly extending from the back end of the body, and a second cutting arm pivotally mounted at the back of the body and extending along the top exterior surface of the body, whereby said second arm can be selectively pivoted between open and closed positions away from and adjacent to the body, respectively, said second cutting arm having a second cutting edge confronting the first cutting edge such when the second arm is in one position a string can be placed between the cutting edges and when the arm is in the other position the cutting edges sever the placed string.

9. The tool of claim 8, including a shield over the cutting edge with through hole whereby when the second arm is in one position the string can be placed through the hole between the cutting edges and when the arm is in the other position the cutting edges severs the placed string.

10. The tool of claim 8, wherein the body has top and bottom surfaces curved in the same direction but with different radii of curvature and the second arm of the string cutter is curved at substantially the same radius of curvature as the body top surface.

11. The tool of claim 1, wherein
the body comprises two half-shells which when joined form a closed, hollow handle sized and shaped to fit in a persons' closed hand;
a tuner mounting plate is situated between the shells adjacent the shell having the surface where the tuning indictor is located;
the transducer and the tuning indicator are situated between the tuner mounting plate and the shell having the surface where the tuning indictor is located; and
a battery for the tuning indicator is situated between the tuner mounting plate and the other shell.

12. The tool of claim 1, wherein
the body comprises two half-shells which when joined form a closed, hollow handle sized and shaped to fit in a persons' closed hand;
a tuner mounting plate is substantially flat with a peripheral edge and is situated between the shells adjacent the shell having the surface where the tuning indictor is located;
the transducer and the tuning indicator are situated between the tuner mounting plate and the shell having the surface where the tuning indictor is located;
a core plate is situated between the tuner mounting plate and the other shell, the core plate having front and back ends, a first side facing the tuning plate, and a second side facing the other shell; and
said first side has a slot at the front end for receiving a disc-shaped battery, and a peripheral edge that supports the peripheral edge of the tuner plate.

13. The tool of claim 8, wherein
the body comprises two half-shells which when joined form a closed, hollow handle sized and shaped to fit in a persons' closed hand;
a tuner mounting plate is situated between the shells adjacent the shell having the surface where the tuning indictor is located;
the transducer and the tuning indicator are situated between the tuner mounting plate and the shell having the surface where the tuning indictor is located;
a core plate is situated between the tuner mounting plate and the other shell;
the first string cutter arm is integral with and extends from the core plate through the back end of the body; and
a battery for the tuning indicator is situated between the tuner mounting plate and the core plate.

14. The tool of claim 13, wherein
the tuner plate is substantially flat with a peripheral edge;
the core plate has front and back ends, a first side facing the tuning plate, and a second side facing the other shell; and
said first side has a slot at the front end for receiving a disc-shaped battery, and a peripheral edge that supports the peripheral edge of the tuner plate.

15. The tool of claim 13, including a protective guard around the cutting edges and a hole through the guard for the placement of the free end of a string to be severed between the cutting edges.

16. The tool of claim 13, wherein the other shell includes a detachable portion for covering the battery.

17. The tool of claim 13, wherein
the tuner mounting plate is a printed circuit board;
the transducer includes a microphone carried by the printed circuit board;
the indicator includes a plurality of light emitting diodes carried by the printed circuit board;
a power on/off switch is mounted on the printed circuit board; and
a mode select button at the surface of the body is operatively associated with the power on/off switch.

18. The tool of claim 13, wherein the indicator includes a lens at the body surface with indicia that are selectively illuminated by the light emitting diodes.

19. A tool for a stringed instrument in which each string is held in tension by a peg having a head with external profile that can be turned to change the tension and thereby tune the string, comprising:
an elongated body having front and back ends shaped for grasping in one hand while the instrument is held with the other hand for tuning;
a peg winder projecting from the front end of the body and including an end-effector formed with an internal profile that is complementary the peg external profile;
a tuning system in the body, including a transducer for receiving energy from a plucked string to be tuned, a frequency analyzer coupled to the transducer for comparing the fundamental frequency of vibration of the plucked string with a target frequency; and
a display coupled to the frequency analyzer and visible on the body while the body is grasped with the peg winder projecting away from user, said display including an indicator commensurate with the difference between the analyzed fundamental frequency of the plucked string and the target frequency.

20. The tool of claim 19, wherein
the body has spaced apart, left and right side surfaces, opposed top and bottom surfaces that connect the side surfaces, and front and back surfaces that together with the side and top surfaces form a closed handle sized and shaped to fit in a persons' closed hand with the stem axis oriented substantially in the same direction as the lifeline of the closed hand;
the side surfaces of the body substantially continuously increase in area from the back to the front ends; and
the transducer is located on the same side surface as the tuning indicator.

21. A tool for a stringed instrument in which each string is held in tension by a peg having a head with standard external profile that can be turned to adjust tension in the string for tuning the string to a target frequency, comprising:
an elongated body having front and back ends and an exterior surface shaped for grasping in one hand;
a peg winder projecting from the front end of the body and including an end-effector formed with an internal profile that is complementary to said standard profile;
a transducer at the surface of the body for receiving energy from a vibrating string to be tuned;
a tuning indicator at the surface of the body, for generating a signal commensurate with the difference between the vibration frequency of the plucked string and the target frequency; and
a string cutter mounted at the back end of the tool.

22. The tool of claim 21, wherein the string cutter comprises a first cutting arm with first cutting edge rigidly extending from the back end of the body, and a second cutting arm pivotally mounted at the back of the body and extending along the top exterior surface of the body, whereby said second arm can be selectively pivoted between open and closed positions away from and adjacent to the body, respectively, said second cutting arm having a second cutting edge confronting the first cutting edge such when the second arm is in one position a string can be placed between the cutting edges and when the arm is in the other position the cutting edges sever the placed string.

23. The tool of claim 22, including a shield over the cutting edge with through hole whereby when the second arm is in one position the string can be placed through the hole between the cutting edges and when the arm is in the other position the cutting edges severs the placed string.

24. The tool of claim 22, wherein the body has top and bottom surfaces curved in the same direction but with different radii of curvature and the second arm of the string cutter is curved at substantially the same radius of curvature as the body top surface.
